(19) United States
(12) Patent Application Publication
(10) Pub. No.: US 2004/0035157 A1
(43) Pub. Date: Feb. 26, 2004

(54) Integrated security point and system and method for securing electronic or other devices

(76) Inventors: Matthew Petrick, Oak Park, IL (US); James Brown, Willowbrook, IL (US)

Correspondence Address: Welsh & Katz, Ltd., Jon P. Christensen, 22nd Floor, 120 South Riverside Plaza, Chicago, IL, 60606, US

(21) Appl. No.: 10/427,831

(22) Filed: May 1, 2003

Related U.S. Application Data
(60) Provisional application No. 60/378,606, filed on May 7, 2002.

(51) Int. Cl. E05B 73/00

(52) U.S. Cl. 70/58

(57) ABSTRACT

A security system comprising an integrated security point is provided. The system permits a user to secure computers and other devices to fixed or mostly immobile objects so as to prohibit, or severely impede, the theft of the computer, device or other object. The system includes means to attach the system to the secure point and means to link the point with the object in such a manner to impede theft.

The present invention relates to an integrated security point (ISP) and a system and method for securing electronic or other devices. In one form of the invention an integrated security point may be fixed to a desktop, a storage cart, an audio visual cart, a work center or other devices, for securing computers or other valuable equipment.

### BACKGROUND OF THE INVENTION

Expensive items are stolen everyday. Whole industries have been developed to keep items from being stolen. Among the ways that have been devised to prevent theft include locked cabinets and safes. However, many items that are targets of theft have everyday applications and cannot be locked away. Such things as computers and other office equipment, stereos, televisions, monitoring devices, medical equipment and the like are susceptible to theft. The prevention of theft while allowing the equipment and devices to be utilized is desirable.

There are presently cable devices used to attach such items as computers to desks. These devices typically require the user to either loop a cable around a desk leg (which security is easily defeated by lifting the desk and removing the loop) or cutting or drilling a hole into the desk so that the cable can be looped through the hole and fastened with a lock. Aside from the obvious damage to the desk, such systems are flawed in that if the desk can be cut to insert the cable it can also be further cut to remove the cable. Often times a desk is more valuable than the device needing protection. Further still, the looping of cable, cutting of furniture and placement of locking mechanisms typically cause an unsightly display in an office or home.

### SUMMARY OF THE INVENTION

In accordance with the present invention, an integrated security system for use in securing items is provided. In a first embodiment, the security system comprises a cable having a first end and a second end and at least one body having an anchoring section and a connection means. The connection means of the security system has a proximal side and a distal side and defining an opening therebetween. The security system further comprises a cable stop, lockably attachable to the first end of the cable. The at least one body being attached to a fixed point, and the first end of the cable being fed through the opening in the connection means of the body such that the first end is about the proximal side. The first cable end being secured to the cable stop; the second end of the cable being attached to an item to be secured to secure the item to the point. In one embodiment, the body is attached to the security point by discrete yet secure means, in other embodiments, the body is an integral part of a piece of furniture or cart.

In a further refinement of the integrated security system, the cable hold is of a size that at least one dimension of the hold has a length greater than the greatest span of the opening defined in the connection means. In this manner the first end of the cable, when attached with a cable hold, cannot pass through the opening in connection means, thereby securing the item to the security point.

Further, in one embodiment, such as in a security system used to secure a laptop computer, the second end of the cable defines means for lockable attachment to the item to be secured. The anchoring section of the first body of the security system comprises a flange. The flange is attachable to a fixed point, such as a desk or a cart in such a manner as to be prohibitively difficult to remove, or steal.

In another embodiment of the integrated security system, the anchor section of the first body is integral with a surface of the cart, having been manufactured therewith. In a further refinement, the entire first body is integral with the cart and can comprise, in one embodiment, an opening defined through a surface of the cart. In another embodiment, the security point is designed so as to appear to be a part of the desk or cart to which it is secured thereby giving an elegant appearance.

In a further embodiment, a cart, desk or other furniture piece, is constructed having a built-in integrated security point. The cart, or other furniture piece, is created with an opening defined in a fixed surface such that a cable can be fed through the opening and anchored with a cable hold. The other end of the cable is then attachable to an item to be secured in the manner described above.

A more detailed explanation of the invention is provided in the following description and claims and is illustrated in the accompanying drawings.

### BRIEF DESCRIPTION OF THE DRAWINGS

FIG. 1 is a schematic representation of the device of the present invention in a first embodiment.

FIG. 1A is a schematic representation of a portion of the device of FIG. 1.

FIG. 2 is a side elevational view of an attachment element of the device of FIG. 1 showing its relationship with a cable in one embodiment.

FIG. 3 is a front elevational view of the attachment element of FIG. 1.

FIG. 3A is an elevational view of an item attachment means.

FIG. 4 is a perspective view, partially cut-away, of a security system made in accordance with the teachings of the present invention.

FIG. 5 is a plan view showing the top of a cart constructed in accordance with one embodiment of the security system of the present invention.

FIG. 6 is an elevational view of the cart of FIG. 4 showing the device of the present invention in use with a laptop computer.

FIG. 7 is a perspective view, partially cut-away, of a security system made in accordance with the teachings of the present invention.

### DETAILED DESCRIPTION OF THE ILLUSTRATIVE EMBODIMENT

While the present invention is susceptible of embodiment in various forms, there is shown in the drawings a number of presently preferred embodiments that are discussed in greater detail hereafter. It should be understood that the present disclosure is to be considered as an exemplification of the present invention, and is not intended to limit the invention to the specific embodiments illustrated. It should be further understood that the title of this section of this application (“Detailed Description of an Illustrative Embodiment”) relates to a requirement of the United States Patent Office, and should not be found to limit the subject matter disclosed herein.

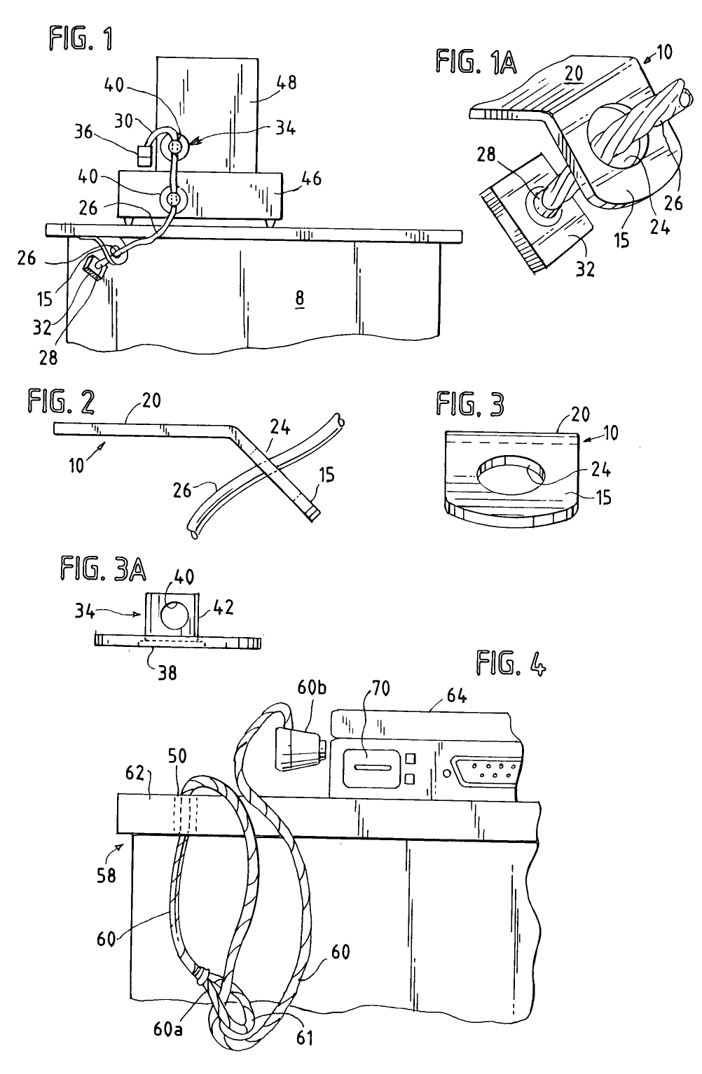

As shown in FIGS. 1, 2 and 3, in one form, the integrated security point (ISP) 10 has a tongue shaped portion 15 angularly affixed to a generally rectangular element 20. The tongue shaped portion 15 has a circular cutout or hole 24 defined therein. It will be understood by persons having skill in the art that while a circular cutout 24 is shown, any shaped opening 24 may be used without departing from the novel scope of the present invention. Further, it will be understood that while the term “cutout” is used, the opening 24 can be created in any manner known in the art, including but not limited to cutting, punching or molding, without departing from the novel scope of the present invention.

The rectangular element 20 may be affixed to the device such as a table, for example, to which one wants to secure a computer or other device or item. This may be done by any conventional means, for example, such as welding the rectangular element 20 to the device. It will be understood that the rectangular element 20 may be affixed to the device by screws, adhesives, magnets, a combination of nuts and bolts, or any other conventional means or combination thereof to attach the element 20 to the device.

In one embodiment of the present invention, the security system 10 includes a security cable 26. As shown in FIG. 1, a security cable 26 fits through cutout 24 in the tongue portion 15 of security system 10. A cable hold 32, comprising a comparably large size element, which in a first embodiment is square shaped but, it will be understood, can be any shape, is securable onto an end 28 of the security cable. Cable hold 32 is configured such that it cannot pass through the opening 24 of the integrated security point 10. In this manner, the end 30 of cable 26 is prevented from passing beyond integrated security point 10 and becomes a point of anchoring for the item or items to be secured. Cable hold 32 can be secured to cable 26 using a number of conventional methods and means of attachment. It will be understood that cable hold 32, in order to be effective as a deterrent to theft, must be either lockably securable or fixedly securable to cable end 32. Means such as specialized locks of types know in the art can lockably secure a cable hold 32 to cable 26. Further, such means as welding, fasteners or adhesives can be used to fixedly secure cable hold 32 to cable 26. Specialized fasteners having security screw or bolt heads (such as hub lock bolts used to secure modern wheels to automobiles), requiring a specialized tool for removal can be used. All such means to secure cable hold 32 can be used by persons having skill in the art without departing from the novel scope of the present invention.

Other embodiments may have the cutout or hole integrated in and located directly on a tabletop, leg channel or other portion of the workstation or device (See for example FIGS. 4 and 5, hole 50). The integrated security point 10 may be used to secure any type of equipment and not only computers such as, for example, televisions, lap top computers, printers, etc.

In one form of the invention, the integrated security point 10 may be welded or otherwise secured to any portion of a workstation or furniture device 8. For example, the integrated security point 10 is secured to the undersurface of a table top, to the top surface of a table top, to a leg portion of the table top, to a back portion of a table top, to a side portion or a table top of any other portion or surface of the furniture device that the ISP 10 is attached.

As shown in FIGS. 1 and 3A, in one form of the invention, a kit may be provided which includes a security system comprising one or more swivel-node security points 34, one heavy duty cable 26 and one locking means 36, which secures a desk top computer 46 and monitor 48 to a table 8 or other furniture device. Swivel node security points 34 consist generally of an attachment base 38 and a tongue portion 42 into which an opening 40 is defined. It will be understood that such devices and others similar in function are well known by persons having ordinary skill in the art. The furniture device 8 is thereby provided with one or more integrated security points 10 securely attached to the furniture device 8 at a location where the security system can be operably and securely connected so as to prevent theft of the computer equipment (46, 48).

In one embodiment of the invention, a method of installation of the system may progress as follows: an installer can wipe clean the base 38 of each needed swivel-node security point 34, with, for example, an alcohol pad, so as to properly prepare the surface for use. The installer can then apply glue, or other adhesive, to each of the swivel-node security point bases 38 needed for a particular installation. If it is desired to secure both a monitor 48 and CPU 46, the installer will prepare at least two bases 38. The installer can then attach one swivel-node security point 34 to the monitor 48 and the other swivel-node security point to the central processing unit (CPU) 46. When the adhesive has set, the installer can then slide an end 30 of the cable through opening 24 of integrated security point 10; securing the other end 28 of cable 26 with a cable hold 32. The cable end 30 can then be fed through opening 40 defined in the swivel-node security point 34 attached to the CPU 46; and then through the opening 40 defined in the swivel-node security point 34 attached to the computer monitor 48. The installer can then fasten a cable hold 36 to end 30 of cable 26, locking the computer 46 and monitor 48 to the ISP 10.

More specifically, a security system 10 can include a 6 foot galvanized steel aircraft cable having a ¼ inch diameter and having a vinyl coating of 8/16 inch diameter, with a 7×19 inch strand. Further, the system 10 can include a 40 millimeter diameter resettable padlock (see FIG. 7) and one or more 50 millimeter diameter swivel-node security points 34. Adhesive from a tube of cyanoacrylate bonding adhesive, or other adhesive may be used to attach the swivel-node security points 34 to each piece of equipment. A 12-gauge mouse/keyboard cord clamp (not shown) may also be included in such a system. A table 8 may be provided featuring one or more integrated security points 10 securely attached to the table 8 as described herein and the ISP 10 may be constructed of 12-gauge CRCQ steel. It will be understood that while the above is a list of desirable elements of the security system a full range of equivalent materials and elements, known in the art, can be substituted without departing from the novel scope of the present invention.

In an embodiment of the present invention used for securing notebook computers, shown in FIG. 4, a security system kit 58 can comprise at least one micro slot cable 60 to secure a notebook computer 64. A table or cart 62 can be provided with one or more integrated security points 50. During use, the micro slot security cable 60 is fed through the integrated security point opening 50. In this embodiment, one end 60a of the micro slot security cable 60 is constructed with a loop 61 and the other end 60b of the micro slot security cable 60 is fed through the loop 61 and tightened so that cable 60 cannot be removed from the integrated security point 50. The security slot 70 built into most notebook computers 64, is located by the user and the free end of the micro slot security cable 60b is secured to the security slot 70 of the notebook computer. The micro slot cable 60 can be of the type having a lock having a resettable combination built therein, or can have other securing means. The ISP table 62 may be constructed of a 12 gauge CRCQ steel or other type of material.

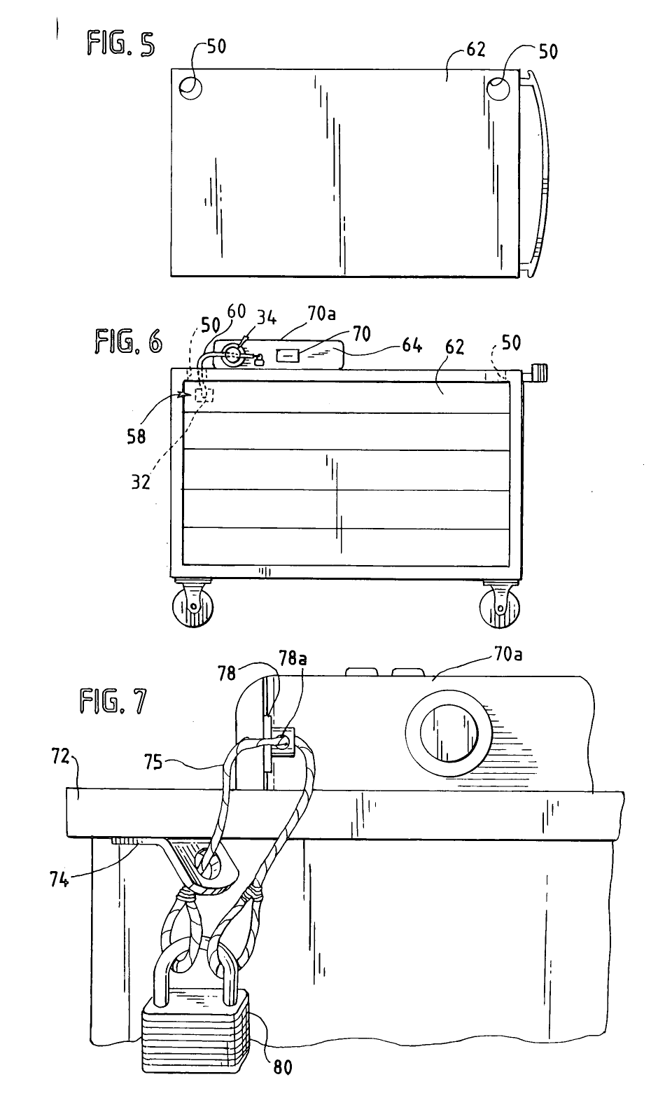

As shown in FIGS. 5 and 6, in yet another form of the invention, a cutout or hole 50 may be provided in a laptop security cart or other furniture device used for holding or storing multimedia equipment and/or computer equipment. In this form of the invention, the cutout 50 may be located on a top surface, a side surface, a front surface or bottom surface of the furniture device. In one form, a security system including a at-least one cable, at least one swivel-node security point, and at least one locking means are provided.

During use, the swivel-node security point is attached to the multimedia device and a first end of the cable is passed through the cutout whereby the second end of the cable having a square or otherwise shaped portion cannot pass through the cutout and whereby the first end of the cable has passed through the opening in the swivel-node security point and is fastened by the locking means so that the cable cannot slide out of the opening in the swivel-node security point.

The security systems as described herein may also be used for securing multimedia equipment to an LCD projection cart or other types of office or classroom furniture.

In another embodiment of the invention, shown in FIG. 7, the security system may be used to secure multimedia equipment 70 to an audio-visual presentation cart 72. In this embodiment of the invention, an audio-visual presentation cart 72 is provided having at least one integrated security point 74 welded, cut into, or otherwise securely attached (as noted in the examples given above) to presentation cart 72; a 6 inch or other length security cable 76, one or more swivel-node security points 78, and one or more padlocks or other locking means 80, to secure the multimedia equipment to the cart, are also provided.

During use, the installer could wipe the swivel-node security point base 74 clean with alcohol or another form of cleaner. The installer would then apply an adhesive to the swivel-node security point base 74 and attach the swivel-node security point 74 to the multimedia equipment 82. Then the installer would then insert an end of cable 76 through the integrated security point opening 74a and insert an end of cable 76 through the swivel-node security point opening 78a. The installer would then secure the cable with a lock 80 or other locking means as described above in other embodiments.

In one embodiment of the device illustrated in FIG. 7, a 6 inch security cable system may comprise a 6 inch galvanized steel aircraft cable which is ¼ inch thick and vinyl coated to 5/16 of an inch diameter with a 7×19 inch strand. Also included is a 40 millimeter diameter resettable combination padlock and three 50 millimeter diameter swivel-node security points. Adhesive from a 3 gram tube of cyanoacrylate bonding adhesive, or other adhesive, can be used to attach the swivel-node security points to the multimedia equipment. A 12 gauge mouse/keyboard cord clamp (not shown) may also be included in the system. Audio video cart 72 can be constructed having one or more integrated security points and can be made from 12 gauge CRCQ steel which can be welded, or otherwise securely attached, to cart 72. As previously noted, equivalents to all of the items specified may be used without departing from the novel scope of the present invention.

Specific embodiments of novel methods and apparatus for construction of novel integrated security points according to the present invention have been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention any and all modifications, variations, or equivalents that fall within the true spirit and scope of the basic underlying principles disclosed and claimed herein.

Although an illustrative embodiment of the invention has been shown and described, it is to be understood that various modifications and substitutions may be made by those skilled in the art without departing from the novel spirit and scope of the invention.

What is claimed is:

1. An integrated security system for use in securing items, comprising:
a cable; and
at least one body having an anchor section, for attachment to a point, and a connection means disposed to secure a cable end, such that the anchoring section of the at least one body is attached to the point, the cable is secured to the connection means of the at least one body and fed from the connection means to an item to be secured and attached to the item so as to secure the item to the point.

2. The integrated security system of claim 1, wherein the connection means includes a proximal side and a distal side with an opening defined therebetween, the cable being fed through the opening.

3. The integrated security system of claim 2, wherein the cable defines a first end and a second end, the cable being secured at the connection means using a cable hold.

4. The integrated security system of claim 3, wherein the cable hold is defined such that at least one dimension has a length greater than the greatest span of the opening defined in the connection means, such that the first end of the cable cannot pass through the opening in the connection means.

5. The integrated security system of claim 3, wherein the second end of the cable defines means for lockable attachment to an item to be secured.

6. The integrated security system of claim 3, wherein the first end of the cable comprises a loop, the loop being fed through the opening in the connection means, the second end of the cable being fed through the loop so as to secure the cable to the connection means.

7. The integrated security system of claim 3, wherein the first end of the cable comprises a loop and the second end of the cable comprises a loop, a second body having an anchoring section is attached to the item to be secured, the second body anchoring section defining an opening, such that said first end of said cable is fed through the opening in the connection means of the point and the second end of the cable is fed through the opening in the anchor section attached to the item to be secured, the first and second end of the cable being secured together by a lock.

8. An integrated security system for use in securing items, comprising:
a cable having a first end and a second end;
at least one body having an anchoring section, for attachment to a point, and a connection means, the connection means having a proximal side and a distal side and defining an opening therebetween;
a cable stop, lockably attachable to the first end of the cable;
the at least one body being attached to a fixed point, the first end of the cable being fed through the opening in the connection means of the body, such that the first end is about the proximal side, the first cable end being secured to the cable stop, the second end of the cable being attached to an item to be secured so as to secure the item to the point.

9. The integrated security system of claim 8, wherein the cable hold defines at least one dimension having a length greater than the greatest span of the opening defined in the connection means, such that the first end of the cable cannot pass through the opening in connection means.

10. The integrated security system of claim 9, wherein the second end of the cable defines means for lockable attachment to an item to be secured.

11. The integrated security system of claim 10, wherein the item to be secured is a laptop computer having a lock down member.

12. The integrated security system of claim 9, wherein the anchoring section comprises a flange.

13. The integrated security system of claim 9, wherein the fixed point is a desk.

14. The integrated security system of claim 9, wherein the point is a cart.

15. The integrated security system of claim 14, wherein the anchor section of the first body is integral with a surface of the cart.

16. The integrated security system of claim 14, wherein the first body is integral with the cart.

17. An integrated security system for use in securing items, comprising:
a cable having a first end and a second end;
cable holds, lockably attachable to the first and second ends of the cable;
a first body, having and anchor section, for attachment to a point, and a connection means, the connection means having a proximal side and a distal side, defining an opening therebetween;
a second body having an anchoring section, for attachment to an item to be secured, and a connection means, the connection means having a proximal side and a distal side, defining an opening therebetween;
the first body being fixedly attachable to a point and the second body being fixedly attachable to an item to be secured;
the cable being disposed between the first and second bodies such that the first end of the cable is proximal of the proximal side of the first body connection means and being lockably attached to a cable hold, the second end of the cable being fed through the opening defined in the first body connection means and through the opening in the second body connection means, the second end of the cable being lockably attached to a second cable hold, such that the item to be secured is secured to the point.

18 The integrated security system of claim 17, wherein the anchoring section of the first body is a flange.

19. The integrated security system of claim 18, wherein the anchoring section of the second body is a lap top security slot.

20. A method of utilizing an integrated security system to secure a device comprising the steps of:
providing a cable having a first end and a second end;
providing at least one cable hold;
providing a security body having an anchoring section, for attachment to a point, and a connection means, the connection means having a proximal side and a distal side and defining an opening therebetween;
attaching the security body to a fixed point;
feeding the first end of the cable though the opening defined in the connection means;
attaching a cable hold to the end of the cable at the proximal side of the connection means; and,
securing the item to be secured with the second end of the cable.

21. The method of utilizing an integrated security system to secure a device, of claim 20 including the steps of providing a second cable hold and a second security body, having a proximal side and a distal side and defining an opening therebetween, attaching the second security body to the item to be secured, feeding the cable through the opening in the second security body and attaching the cable hold to the second end of the cable distal to the opening in the second security body.

22. An integrated security system for use in securing items, comprising:
a cable having a first end and a second end;
an item of furniture having a connection means, the connection means having a proximal side and a distal side and defining an opening therebetween;
a cable stop, lockably attachable to the first end of the cable;
the first end of the cable being fed through the opening in the connection means of the furniture, such that the first end is about the proximal side, the first cable end being secured to the cable stop, the second end of the cable being attached to an item to be secured so as to secure the item to the item of furniture.

23 The integrated security system of claim 22, wherein the connection means is a surface of the item of furniture, such that the opening defined is defined through that surface.

24. The integrated security system of claim 22, wherein the cable hold defines at least one dimension having a length greater than the greatest span of the opening defined in the connection means, such that the first end of the cable cannot pass through the opening in connection means.

25. The integrated security system of claim 23, wherein the second end of the cable defines means for lockable attachment to an item to be secured.

26. The integrated security system of claim 24, wherein the item to be secured is a laptop computer having a lock down member.

27. The integrated security system of claim 22, wherein the item of furniture is a desk.

28. The integrated security system of claim 22, wherein the item of furniture is a cart.
